(19) United States
(12) Patent Application Publication
(10) Pub. No.: US 2024/0118171 A1
(43) Pub. Date: Apr. 11, 2024

(54) PLANT MONITORING METHOD, PLANT MONITORING DEVICE, AND PLANT MONITORING PROGRAM

(71) Applicant: MITSUBISHI HEAVY INDUSTRIES, LTD., Tokyo (JP)

(72) Inventors: Ichiro NAGANO, Kanagawa (JP); Mayumi SAITO, Tokyo (JP); Kuniaki AOYAMA, Hyogo (JP); Keiji EGUCHI, Tokyo (JP)

(21) Appl. No.: 18/278,293

(22) PCT Filed: Apr. 19, 2022
(86) PCT No.: PCT/JP2022/018157

§ 371 Date: Aug. 22, 2023

(30) Foreign Application Priority Data
May 14, 2021 (JP) 2021-082212

(51) Int. Cl. G01M 15/14

(52) U.S. Cl. CPC G01M 15/14

(57) ABSTRACT

A plant monitoring method using a Mahalanobis distance calculated from data of a plurality of variables indicating the state of the plant. The plant monitoring method includes: acquiring data in a first period in the past up to the current point of time as first data; predicting data in a second period from the current point of time as second data; and creating, on the basis of the first data and the second data, a unit space that serves as a base for calculating the Mahalanobis distance. In the prediction step, the second data is predicted on the basis of: data in a third period obtained, as third data, by shifting the first period to the past by a prescribed period; data in a fourth period obtained, as fourth data, by shifting the second period to the past by the prescribed period, and the first data.

### TECHNICAL FIELD

The present disclosure relates to a plant monitoring method, a plant monitoring device, and a plant monitoring program.

The present application claims priority based on Japanese Patent Application No. 2021-082212 filed in Japan on May 14, 2021, the contents of which are incorporated herein by reference.

### BACKGROUND ART

A plant may be monitored by using a Mahalanobis distance indicating a discrepancy between a reference data set of variables indicating states of a plant (such as a state quantity that can be acquired by sensors) and measurement data for the variable.

PTL 1 discloses that a Mahalanobis distance is calculated by using a plurality of unit spaces set in accordance with an operation period in a plant monitoring method using a Mahalanobis distance. A unit space is an aggregate of pieces of data that are used as references when it is determined whether or not an operation state of the plant is normal. More specifically, in PTL 1, the Mahalanobis distance for the data acquired in a start-up operation period of the plant is calculated by using the unit space created based on the state quantity of the plant in the start-up operation period of the plant, and the Mahalanobis distance for the data acquired in a load operation period of the plant is calculated by using the unit space created based on the state quantity of the plant in the load operation period of the plant.

### CITATION LIST

### Patent Literature

[PTL 1] Japanese Patent No. 5031088

### SUMMARY OF INVENTION

### Technical Problem

The unit space that is a base for calculating the Mahalanobis distance usually includes pieces of data (pieces of reference data) acquired by sensors in a past period. In a case where a Mahalanobis distance for measurement data (evaluation target data) at a point in time (for example, a current point in time or a point in time in the near future) in a period after the past period (period in which the reference data is acquired) is calculated by using such a unit space, a trend of data in the past period in which the reference data is acquired may not coincide with a trend of the data in the period in which the evaluation target data is acquired. In this case, the accuracy of anomaly detection of the plant based on the Mahalanobis distance calculated for the evaluation target data may not be satisfactory.

In view of the above circumstances, an object of at least one embodiment of the present invention is to provide a plant monitoring method, a plant monitoring device, and a plant monitoring program capable of accurately detecting an anomaly in a plant.

### Solution to Problem

A plant monitoring method according to at least one embodiment of the present invention is a plant monitoring method using a Mahalanobis distance calculated from pieces of data of a plurality of variables indicating states of a plant. The method includes a step of acquiring pieces of first data which are pieces of data of a past first period up to a current point in time, a prediction step of predicting pieces of second data which are pieces of data of a second period after the current point in time, and a unit space creation step of creating a unit space which is a base for calculating the Mahalanobis distance based on the pieces of first data and the pieces of second data. In the prediction step, the pieces of second data are predicted based on pieces of third data which are pieces of data of a third period obtained by shifting the first period to the past by a prescribed length of time, pieces of fourth data which are pieces of data of a fourth period obtained by shifting the second period to the past by the prescribed length of time, and the pieces of first data.

In addition, a plant monitoring device according to at least one embodiment of the present invention is a plant monitoring device using a Mahalanobis distance calculated from pieces of data of a plurality of variables indicating states of a plant. The device includes an acquisition unit configured to acquire pieces of first data which are pieces of data of a past first period up to a current point in time, a prediction unit configured to predict pieces of second data which are pieces of data of a second period after the current point in time, and a unit space creation unit configured to create a unit space which is a base for calculating the Mahalanobis distance based on the pieces of first data and the pieces of second data. The prediction unit is configured to predict the pieces of second data based on pieces of third data which are pieces of data of a third period obtained by shifting the first period to the past by a prescribed length of time, pieces of fourth data which are pieces of data of a fourth period obtained by shifting the second period to the past by the prescribed length of time, and the pieces of first data.

In addition, a plant monitoring program according to at least one embodiment of the present invention is a plant monitoring program using a Mahalanobis distance calculated from pieces of data of a plurality of variables indicating states of a plant causing a computer to execute a procedure of acquiring pieces of first data which are pieces of data of a past first period up to a current point in time, a procedure of predicting pieces of second data which are pieces of data of a second period after the current point in time, and a procedure of creating a unit space which is a base for calculating the Mahalanobis distance based on the pieces of first data and the pieces of second data. In the procedure of predicting the pieces of second data, the pieces of second data are predicted based on pieces of third data which are pieces of data of a third period obtained by shifting the first period to the past by a prescribed length of time, pieces of fourth data which are pieces of data of a fourth period obtained by shifting the second period to the past by the prescribed length of time, and the pieces of first data.

### Advantageous Effects of Invention

According to at least one embodiment of the present invention, at least one embodiment of the present invention provides a plant monitoring method, a plant monitoring device, and a plant monitoring program capable of accurately detecting an anomaly in a plant.

### BRIEF DESCRIPTION OF DRAWINGS

FIG. 1 is a schematic configuration diagram of a gas turbine included in a plant to which a monitoring method according to some embodiments is applied.

FIG. 2 is a schematic configuration diagram of a plant monitoring device according to an embodiment.

FIG. 3 is a flowchart of a plant monitoring method according to the embodiment.

FIG. 4A is a diagram for describing the plant monitoring method according to the embodiment.

FIG. 4B is a diagram for describing the plant monitoring method according to the embodiment.

FIG. 5 is a diagram schematically illustrating an example of a unit space created based on a plurality of variables indicating states of a plant.

FIG. 6 is a schematic graph representing an example of measurement data for the variable indicating the state of the plant.

FIG. 7 is a schematic graph representing an example of the measurement data for the variable indicating the state of the plant.

FIG. 8 is a schematic graph representing an example of the measurement data for the variable indicating the state of the plant.

FIG. 9 is a schematic graph representing an example of the measurement data for the variable indicating the state of the plant.

FIG. 10 is a table representing an example of a correspondence relationship between the plurality of variables indicating the states of the plant and a prescribed length of time (a fluctuation cycle of the measurement data).

### DESCRIPTION OF EMBODIMENTS

Hereinafter, some embodiments of the present invention will be described with reference to the accompanying drawings. Dimensions, materials, shapes, relative arrangements, and the like of components described as embodiments or illustrated in the drawings are not intended to limit the scope of the present invention, but are merely explanatory examples.

(Configuration of Plant Monitoring Device)

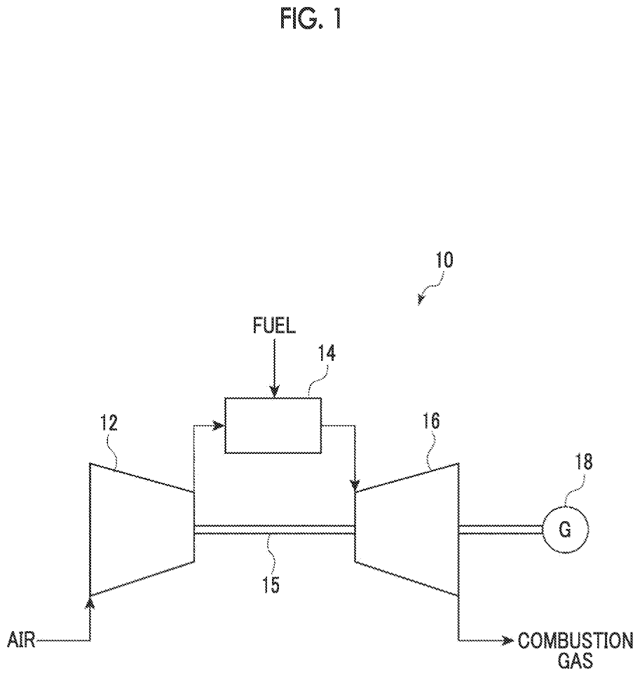

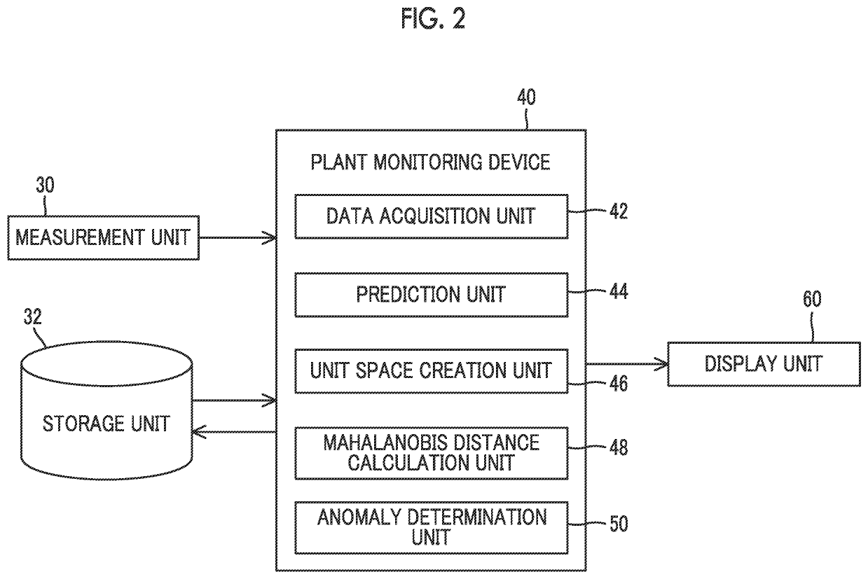

FIG. 1 is a schematic configuration diagram of a gas turbine which is an example of equipment included in a plant to which a monitoring method according to some embodiments are applied. FIG. 2 is a schematic configuration diagram of a plant monitoring device according to an embodiment.

A gas turbine 10 illustrated in FIG. 1 includes a compressor 12 for compressing air, a combustor 14 for combusting fuel together with the compressed air from the compressor 12, and a turbine 16 driven by combustion gas generated in the combustor 14. A generator 18 is connected to a rotor 15 of the gas turbine 10, and the generator 18 is rotationally driven by the gas turbine 10.

In some embodiments, a plant to be monitored includes the gas turbine 10. In some embodiments, the plant to be monitored may include other equipment (for example, a steam turbine).

A plant monitoring device 40 illustrated in FIG. 2 is configured to monitor the plant based on measurement values of a plurality of variables indicating states of the plant measured by a measurement unit 30.

The measurement unit 30 is configured to measure the plurality of variables indicating the states of the plant. The measurement unit 30 may include a plurality of sensors configured to measure the plurality of variables indicating the states of the plant.

In the case of the plant including the gas turbine 10, the measurement unit 30 may include sensors configured to measure, as the variables indicating the states of the plant, a rotor rotation speed, a blade path temperature of each stage, a blade path average temperature, a turbine inlet pressure, a turbine outlet pressure, a generator output, an intake filter inlet pressure, and an intake filter outlet pressure of the gas turbine 10.

The plant monitoring device 40 is configured to receive signals indicating the measurement values of the variables indicating the states of the plant from the measurement unit 30. The plant monitoring device 40 may be configured to receive the signals indicating the measurement values from the measurement unit 30 at each prescribed sampling cycle. In addition, in addition, the plant monitoring device 40 is configured to process the signals received from the measurement unit 30 to determine the presence or absence of an anomaly in the plant. The determination result by the plant monitoring device 40 may be displayed on a display unit 60 (display or the like).

As illustrated in FIG. 2, the plant monitoring device 40 according to the embodiment includes a data acquisition unit (acquisition unit) 42, a prediction unit 44, a unit space creation unit 46, a Mahalanobis distance calculation unit 48, and an anomaly determination unit 50.

The plant monitoring device 40 includes a computer including a processor (CPU or the like), a main storage device (memory device; RAM or the like), an auxiliary storage device, an interface, or the like. The plant monitoring device 40 receives the signals indicating the measurement values of the variables indicating the states of the plant from the measurement unit 30 via the interface. The processor is configured to process the signals received in this manner. In addition, the processor is configured to process a program loaded into the storage device. Accordingly, functions of functional units (data acquisition unit 42 and the like) are realized.

Processing contents in the plant monitoring device 40 are implemented as programs executed by the processor. The programs may be stored in an auxiliary storage unit. When the programs are executed, these programs are loaded into the storage device. The processor reads the program from the storage device and executes a command included in the program.

The data acquisition unit 42 is configured to acquire pieces of data (pieces of first data, pieces of third data, and pieces of fourth data) of a plurality of variables (V1, V2, . . . , and Vn) indicating the states of the plant at a plurality of times t (t1, t2, . . . ) within prescribed periods (a first period, a third period, and a fourth period to be described later) before a current point in time. In the case of the plant including the gas turbine 10, the variables (V1, V2, . . . , and Vn) indicating the states of the plant may include any of the rotor rotation speed of the gas turbine 10, the blade path temperature of each stage, the blade path average temperature, the turbine inlet pressure, the turbine outlet pressure, the generator output, the intake filter inlet pressure, and the intake filter outlet pressure. The pieces of data of the variables at the times t may be representative values (for example, average values) of the measurement values of the variables in the prescribed periods with the times t as a reference.

The data acquisition unit 42 may be configured to acquire the pieces of data based on the measurement values of the plurality of variables measured by the measurement unit 30. The measurement values of the plurality of variables or the pieces of data based on the measurement values may be stored in a storage unit 32. The data acquisition unit 42 may be configured to acquire the measurement values or the pieces of data based on the measurement values from the storage unit 32.

The storage unit 32 may include the main storage device or the auxiliary storage device of the computer constituting the plant monitoring device 40. Alternatively, the storage unit 32 may include a remote storage device connected to the computer via a network.

The prediction unit 44 is configured to predict pieces of data (pieces of second data) of the plurality of variables in prescribed periods (second periods to be described later) after a current point in time, based on the pieces of data of the plurality of variables in the prescribed periods before a current point in time acquired by the data acquisition unit 42.

The unit space creation unit 46 is configured to create unit spaces which are a base for calculating Mahalanobis distances based on the pieces of first data acquired by the data acquisition unit 42 and on the pieces of second data acquired by the prediction unit 44.

The unit space is a group (a set of normal data) that is homogeneous with respect to a goal, and a distance of data which is an evaluation target (diagnosis target) from a center of the unit space is calculated as the Mahalanobis distance. When the Mahalanobis distance is small, the data which is the evaluation target is likely to be normal, and when the Mahalanobis distance is large, the data which is the evaluation target is likely to be anomalous.

The Mahalanobis distance calculation unit 48 is configured to calculate the Mahalanobis distance for the data which is the evaluation target by using the unit space created by the unit space creation unit 46.

The anomaly determination unit 50 is configured to determine the presence or absence of an anomaly in the plant based on the Mahalanobis distance calculated by the Mahalanobis distance calculation unit 48.

(Plant Monitoring Flow)

Hereinafter, a plant monitoring method according to some embodiments will be described in more detail. Although a case where the plant monitoring method according to one embodiment is executed by using the plant monitoring device 40 will be described below, the plant monitoring method may be executed by using another device in some embodiments.

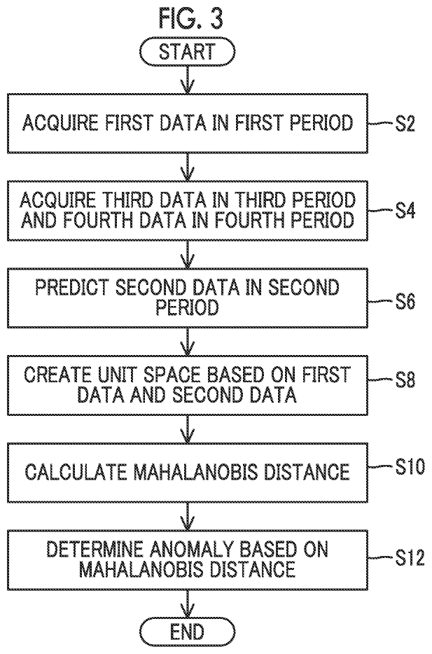

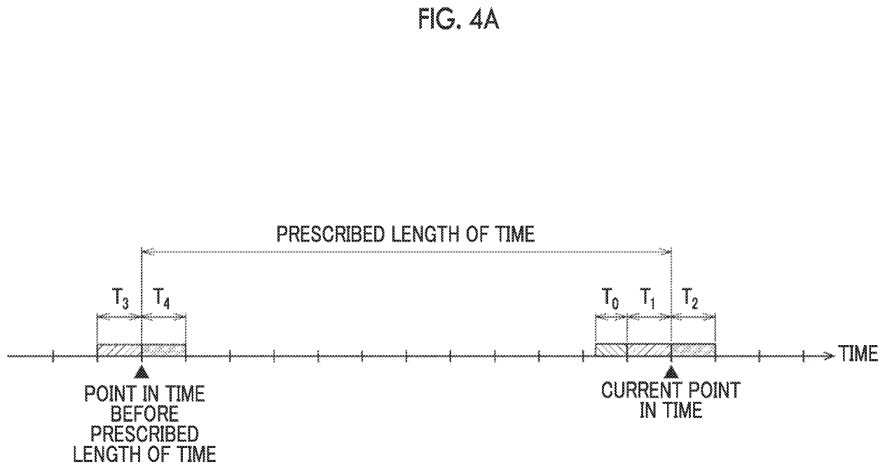

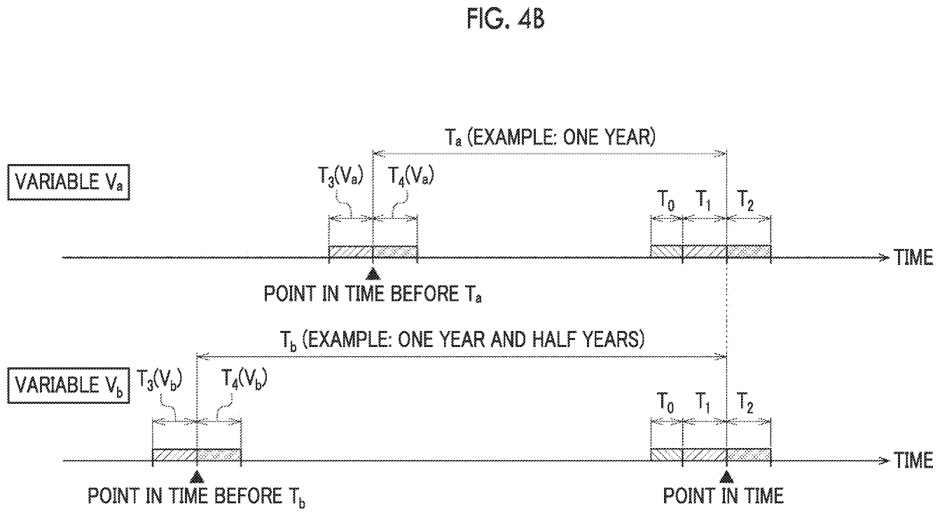

FIG. 3 is a flowchart illustrating the plant monitoring method according to some embodiments. FIGS. 4A and 4B are diagrams for describing the plant monitoring method according to some embodiments.

As illustrated in FIG. 3, in some embodiments, first, the data acquisition unit 42 acquires the pieces of first data which are pieces of data of the plurality of variables (V1, V2, . . . , and Vn) indicating the states of the plant at the plurality of times in a first period T1 (see FIG. 4A) in the past up to a current point in time (S2). That is, the pieces of first data include a set of the pieces of data (data set) of the plurality of variables (V1, V2, . . . , and Vn) at the plurality of times in the first period T1.

In the present specification, the “current point in time” means a specific point in time (reference point in time), and is not limited to a current time and may be a point in time before the current time.

In addition, the data acquisition unit 42 acquires the pieces of third data which are pieces of data of the plurality of variables (V1, V2, . . . , and Vn) indicating the states of the plant at the plurality of times in a past third period T3 (see FIG. 4A), and acquires the pieces of fourth data which are pieces of data of the plurality of variables (V1, V2, . . . , and Vn) indicating the states of the plant at the plurality of times in a past fourth period T4 (see FIG. 4A) (S4).

As illustrated in FIG. 4A, the third period T3 is a period in which the first period T1 is shifted to the past by a prescribed length of time. That is, the third period T3 is a period corresponding to the first period T1 before a prescribed length of time from a current point in time. A start point in time of the third period T3 is a point in time before the prescribed length of time from a start point in time of the first period T1, and an end point in time of the third period T3 is a point in time before a prescribed length of time from the first period T1. In addition, a length of the third period T3 is equal to a length of the first period T1.

As illustrated in FIG. 4A, the fourth period T4 is a period in which a second period T2 after a current point in time is shifted to the past by a prescribed length of time. That is, the fourth period T4 is a period corresponding to the second period T2 before a prescribed length of time from a current point in time. A start point in time of the fourth period T4 is a point in time before a prescribed length of time from a start point in time of the second period T2, and an end point in time of the fourth period T4 is a point in time before a prescribed length of time from an end point in time of the second period T2. In addition, a length of the fourth period T4 is equal to a length of the second period T2.

The pieces of third data (the pieces of third data for the plurality of variables) may be a set of pieces of data of the variables of the third period T3 obtained by shifting the first period T1 to the past by a prescribed length of time defined for each of the plurality of variables, and the pieces of fourth data (the pieces of fourth data for the plurality of variables) may be a set of pieces of data of the variables of the fourth period T4 obtained by shifting the second period T2 to the past by a prescribed length of time defined for each of the plurality of variables. That is, a shift amount of the time (a length of a retroactive time; that is, the prescribed length of time) from the first period T1 and the second period T2 to the third period T3 and the fourth period T4 may be defined for each of the plurality of variables.

For example, as illustrated in FIG. 4B, the pieces of third data for the plurality of variables (including Va and Vb) may include data of the variable Va of the third period T3 (Va) obtained by shifting the first period T1 to the past by a prescribed length of time Ta (for example, one year) for the variable Va and data of the variable Vb of the third period T3 (Vb) obtained by shifting the first period T1 to the past by a prescribed length of time Tb (for example, one year and a half years) for the variable Vb. The pieces of fourth data for the plurality of variables may include data of the variable Va of the fourth period T4 (Va) obtained by shifting the second period T2 to the past by a prescribed length of time Ta for the variable Va and data of the variable Vb of the fourth period T4 (Vb) obtained by shifting the second period T2 to the past by a prescribed length of time Tb for the variable Vb.

That is, the pieces of third data of the plurality of variables (V1, V2, . . . , and Vn) include a set of the pieces of data (data set) at the plurality of times in the third period T3 for the plurality of variables (V1, V2, . . . , and Vn). In addition, the pieces of fourth data of the plurality of variables (V1, V2, . . . , and Vn) are a set of the pieces of data (data set) at the plurality of times in the fourth period T4 for the plurality of variables (V1, V2, . . . , and Vn).

Hereinafter, in the present specification, data for a specific variable included in the pieces of third data of the plurality of variables may be referred to as third data for the variable. In addition, data for a specific variable included in the pieces of fourth data of the plurality of variables may be referred to as fourth data for the variable.

Subsequently, the prediction unit 44 predicts the pieces of second data which are pieces of data of the plurality of variables (V1, V2, . . . , and Vn) indicating the states of the plant in the second period T2 (see FIGS. 4A and 4B) after a current point in time based on the first data of the first period T1 acquired in step S2 and on the third data of the third period T3 and the fourth data of the fourth period T4 acquired in step S4 (S6). The pieces of second data include a plurality of sets of the pieces of data (data sets) of the plurality of variables (V1, V2, . . . , and Vn) in the second period T2. Typically, the length of the second period T2 is equal to the length of the first period T1. A procedure for predicting the pieces of second data in step S6 will be described later.

Subsequently, the unit space creation unit 46 creates the unit spaces which are the base for calculating the Mahalanobis distances in subsequent step S10 based on the pieces of first data acquired in step S2 and on the pieces of second data predicted in step S6 (S8). That is, in step S8, pieces of data constituting the unit space are selected from among the pieces of first data and the pieces of second data.

In step S8, the unit spaces may be created by using at least some of the pieces of first data acquired in step S2 and at least some of the pieces of second data acquired in step S6. In addition, in step S8, the unit spaces may be created by using pieces of data of the plurality of variables (V1, V2, . . . , and Vn) acquired in a period TO (see FIGS. 4A and 4B) before the first period up to the first period in which the pieces of first data are acquired in addition to at least some of the pieces of first data and at least some of the pieces of second data.

Then, the Mahalanobis distance calculation unit 48 calculates the Mahalanobis distance for the data (signal space data) which is the evaluation target (diagnosis target) by using the unit space created by the unit space creation unit 46 (310). Typically, in step S10, measurement values (Y1, Y2, . . . , and Yn) of the plurality of variables (V1, V2, . . . , and Vn) acquired within a period after a current point in time are the data (signal space data) which is the evaluation target, and the Mahalanobis distance is calculated for the data.

The Mahalanobis distance for the data which is the evaluation target can be calculated by the method described in PTL 1. However, the method for calculating the Mahalanobis distance can be schematically described as follows. First, an average for each item (variable) is obtained by the following Equation (A) by using the pieces of data (data sets (X₁, X₂, . . . , and Xₙ) for n variables (V1, V2, . . . , and Vn)) constituting the unit space. In the following equation, k is the number of pieces of data (the number of data sets) of the n variables constituting the unit space.

$$\\ \begin{matrix}\overline{{X}_{i}} = \frac{1}{k} {\sum }_{k} {X}_{ik} & ( A )\end{matrix}$$

Subsequently, a covariance matrix COV (n×n matrix) is obtained for the pieces of data constituting the unit space by the following Equation (B) by using an average for each item (variable) calculated by the above Equation (A).

$$\\ \begin{matrix}{cov}_{ij} = \frac{1}{k} {\sum }_{k} ( {X}_{ik} - \overline{{X}_{i}} ) ( {X}_{jk} - \overline{{X}_{j}} ) & ( B )\end{matrix}$$

Then, a squared value D² of a Mahalanobis distance D is calculated by the following Equation (C) by using pieces of data Y₁ to Yₙ which are evaluation targets, the averages obtained by the above Equation (A), and an inverse matrix of the covariance matrix obtained by the above Equation (B). In the following equation, l is the number of pieces of data (number of data sets) of the pieces of data (pieces of signal space data) Y₁ to Yₙ which are the evaluation targets for n variables.

$$\\ \begin{matrix}{D}^{2} = \begin{matrix}( {Y}_{1 l} - \overline{{X}_{1}} & … & {Y}_{nl} - \overline{{X}_{n}} ) {COV}^{- 1}\end{matrix} ( \begin{matrix}{Y}_{1 l} - \overline{{X}_{1}} \\ ⋮ \\ {Y}_{nl} - \overline{{X}_{n}}\end{matrix} ) & ( C )\end{matrix}$$

Subsequently, the anomaly determination unit 50 determines the presence or absence of an anomaly in the plant based on the Mahalanobis distance D calculated in step S10 (S12). In step S12, the anomaly determination unit 50 may determine the presence or absence of an anomaly in the plant based on the comparison between the Mahalanobis distance D and a threshold value. For example, when the Mahalanobis distance D calculated in step S10 is equal to or less than the threshold value, the anomaly determination unit 50 may determine that the plant is normal, and when the Mahalanobis distance D is more than the threshold value, the anomaly determination unit may determine that an anomaly has occurred in the plant.

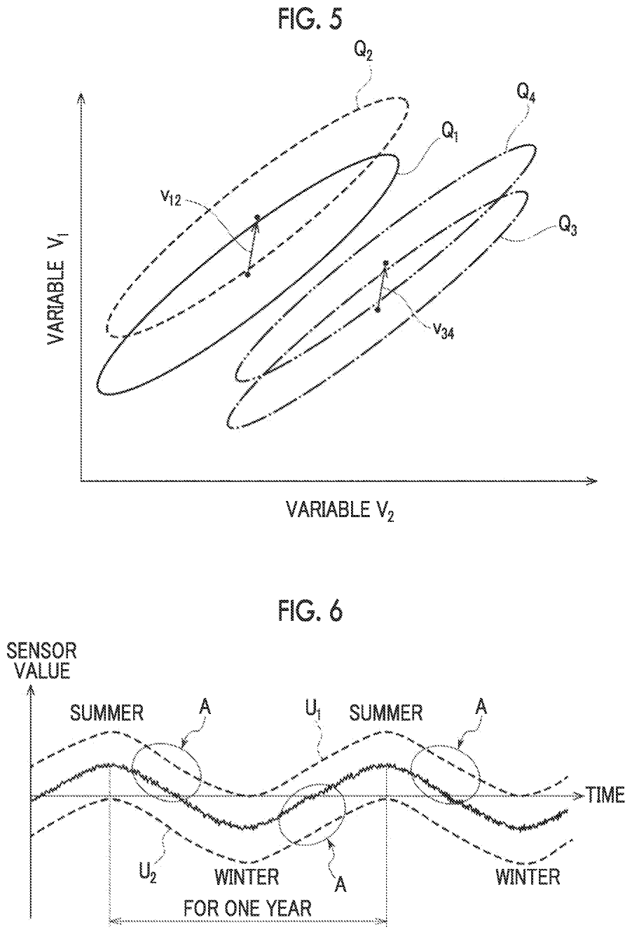

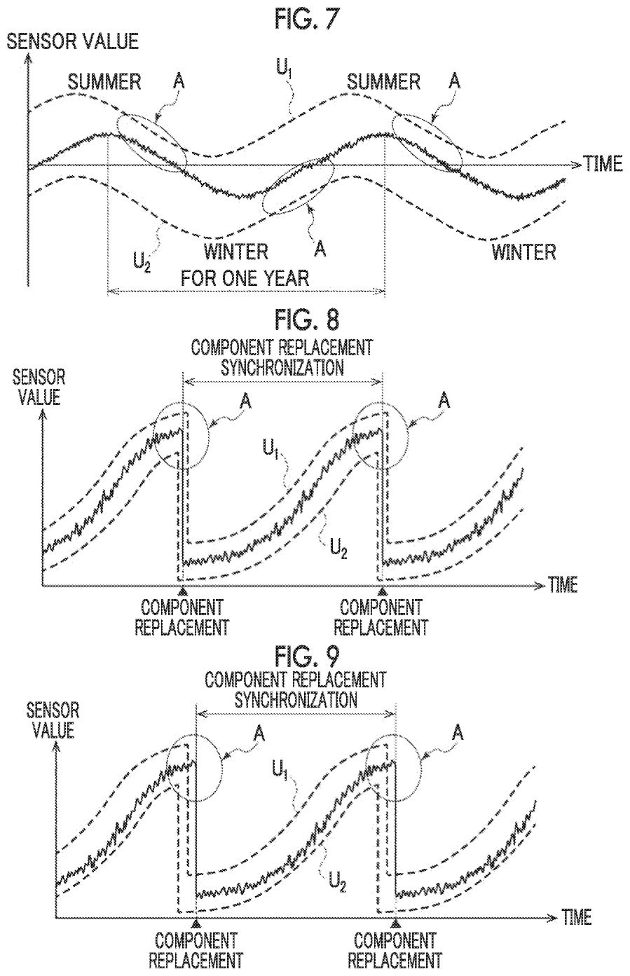

FIG. 5 is a diagram schematically illustrating an example of the unit space created based on the plurality of variables indicating the states of the plant. FIGS. 6 and 7 and FIGS. 8 and 9 are schematic graphs representing an example of pieces of measurement data for the variables indicating the states of the plant. In FIGS. 6 and 7 and in FIGS. 8 and 9, solid lines represent the pieces of measurement data (sensor values) for the variables indicating the states of the plant, and a region between a pair of curves U1 and U2 (broken lines) represents the unit space that is the base for calculating the Mahalanobis distance.

The pieces of measurement data (for example, a temperature, a pressure, and the like) for the plurality of variables indicating the states of the plant include pieces of data that fluctuate periodically as illustrated in FIGS. 6 and 7 and FIGS. 8 and 9. The pieces of measurement data of the variables illustrated in FIGS. 6 and 7 are accompanied by seasonal fluctuations in a one-year cycle, and include, for example, measurement data by a temperature sensor. The pieces of measurement data of the variables illustrated in FIGS. 8 and 9 are accompanied by fluctuations of pieces of plant constituent equipment in a component replacement cycle, and include pieces of measurement data by sensors that measure outlet pressures of an intake filter (of components of the pieces of plant constituent equipment). The pieces of measurement data accompanied by the fluctuations in the component replacement cycle are such that the fluctuations in the pieces of measurement data are influenced by an elapsed time from a component replacement point in time.

It is considered that the Mahalanobis distance is calculated for the measurement data acquired at a current point in time (or a point in time in the near future from the current point in time, for example, a point in time within the second period T2).

In this case, when the unit spaces are created by using only the pieces of data of the plurality of variables acquired in a most recent past period (for example, the first period), as illustrated in FIG. 7 or 9, a time difference occurs between a periodic fluctuation of the measurement data (solid line) and a periodic fluctuation of the unit space (the region between the curve U1 and the curve U2). As a result, a period (region A in the drawing) in which a distance of the measurement data from the center of the unit space increases is generated. In such a period, it is easy for calculation to result in a large Mahalanobis distance and for an anomaly of the plant to be erroneously determined. In some cases, accuracy of anomaly detection is not satisfactory.

In contrast, in the above embodiment, the pieces of second data can be predicted in consideration of periodic fluctuations in the pieces of data of the plurality of variables based on the pieces of third data and the pieces of fourth data acquired in the past periods (the third period T3 and the fourth period T4) before a prescribed length of time corresponding to the first period T1 and the subsequent second period T2 and on the pieces of first data acquired in the first period T1. This is because, for example, as illustrated in FIG. 5, for the data of a certain variable, the fluctuations in the pieces of data between the first period T1 and the subsequent second period T2 correspond to the fluctuations in the pieces of data between the third period T3 before a prescribed length of time (for example, one year or a component replacement cycle) corresponding to the first period T1 and the fourth period T4 before a prescribed length of time corresponding to the second period T2. Then, in the above embodiment, the unit spaces in which the seasonal fluctuations are taken into consideration can be created by using the pieces of second data predicted in this manner and the pieces of first data based on an actually measured value together.

When the unit spaces are created in this manner, as illustrated in FIG. 6 or 8, it becomes easier for a trend of the periodic fluctuation of the measurement data (solid line) and a trend of the periodic fluctuation of the unit space (the region between the curve U1 and the curve U2) to coincide with each other. As a result, the calculated Mahalanobis distance is less influenced by the periodic fluctuation in the measurement data. For example, in FIG. 6 or 8, in the period corresponding to the region A (the region corresponding to the region A in FIG. 7 or 9), the distance of the measurement data from the center of the unit space is equal to other periods.

Thus, an anomaly in the plant can be accurately detected by using the Mahalanobis distances calculated based on the unit spaces created in this manner.

Note that, in FIG. 5, ellipses Q1 to Q4 are diagrams schematically illustrating examples of unit spaces created based on the pieces of first data to the pieces of fourth data, respectively. Each ellipse is a set of points of which Mahalanobis distances calculated from the unit spaces are equal. In FIG. 5, for the sake of simplification, unit spaces based on two variables V1 and V2 are schematically illustrated. As illustrated in FIG. 5, a change in a position of a unit space Q2 based on the pieces of second data for a unit space Q1 based on the pieces of first data corresponds to a change in a position of a unit space Q4 based on the pieces of fourth data for a unit space Q3 based on the pieces of third data. That is, an orientation of a fluctuation vector v₁₂ of a center of the unit space Q2 with respect to a center of the unit space Q1 and an orientation of a fluctuation vector V₃₄ of a center of the unit space Q4 with respect to a center of the unit space Q3 are substantially the same. Lengths of these fluctuation vectors are also influenced by a degree of variation (size of the ellipse) of the data constituting the unit space. In FIG. 5, the variations of the pieces of data constituting the unit space Q3 and the unit space Q4 are smaller than the variations of the pieces of data constituting the unit space Q1 and the unit space Q2. Thus, a length of the fluctuation vector v₃₄ is shorter than a length of the fluctuation vector v₁₂. Accordingly, in step S6, the pieces of second data can be predicted more appropriately by considering a difference in the degree of variation of the pieces of data in each period.

In some embodiments, the prescribed length of time (the shift amount of the time from the first period T1 and second period T2 to the third period T3 and the fourth period T4) defined for at least one variable (for example, Va) among the plurality of variables (V1, V2, . . . , and Vn) is one year.

The pieces of data of the plurality of variables indicating the states of the plant usually include pieces of data that fluctuate in a one-year cycle depending on the season. In this regard, according to the above embodiment, since the pieces of second data are predicted by using the pieces of third data and the pieces of fourth data including the data for at least one variable (Va) acquired in the periods (the third period T3 and the fourth period T4) one year before the periods corresponding to the first period T1 and the second period T2, the pieces of second data can be accurately predicted in consideration of the seasonal fluctuation in the data of the variable (Va).

In some embodiments, the prescribed length of time (the shift amount of time from the first period T1 and the second period T2 to the third period T3 and the fourth period T4) defined for at least one other variable (for example, Vb) among the plurality of variables (V1, V2, . . . , and Vn) is a component replacement cycle of the plant constituent equipment related to the other variable (Vb). For example, the plant constituent equipment may be an intake filter of a gas turbine.

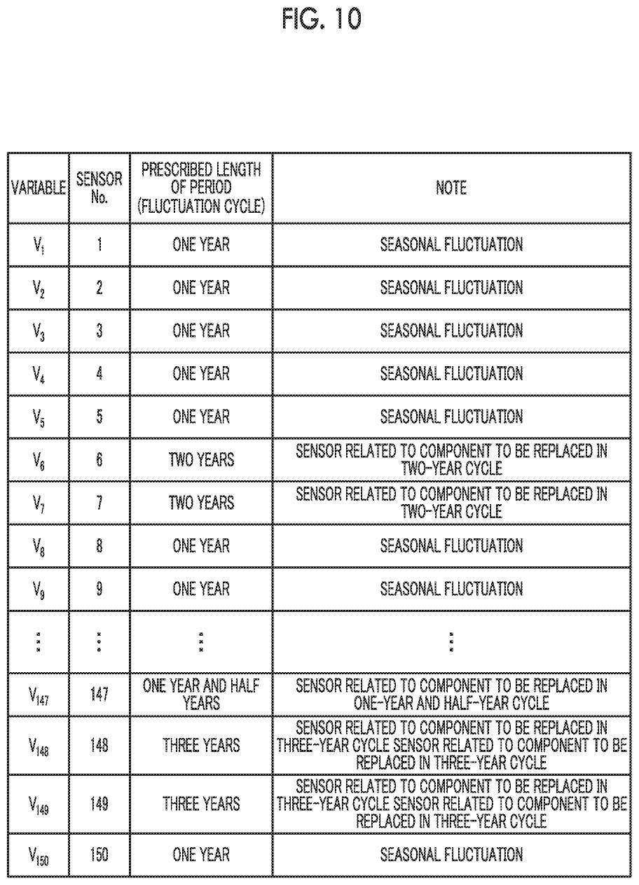

FIG. 10 is a table representing an example of a correspondence relationship between a number of a sensor (sensor No.) corresponding to each of a plurality of variables (V1, V2, . . . , and V150) indicating the states of the plant and the prescribed length of time (the shift amount of the time from the first period T1 and the second period T2 to the third period T3 and the fourth period T4) defined for each of the plurality of variables (sensors).

As illustrated in FIG. 10, the prescribed length of time (the shift amount of the time from the first period T1 and the second period T2 to the third period T3 and the fourth period T4) can be individually set for each of the plurality of variables. As illustrated in FIG. 10, in a case where the prescribed length of time is set for the plurality of variables based on the component replacement cycle of the plant constituent equipment, the component replacement cycle (that is, the prescribed length of time) may be different depending on a type of the component and the like.

The pieces of data of the plurality of variables indicating the states of the plant may include pieces of data that fluctuate in the component replacement cycle of the plant constituent equipment related to the variable. In this regard, according to the above embodiment, the pieces of second data are predicted by using the pieces of third data and the pieces of fourth data including the data for the at least one variable (Va) acquired in the periods (the third period T3 and the fourth period T3) one year before the periods corresponding to the first period T1 and the second period T2 and the data for the at least one other variable (Vb) acquired in the period (the third period T3 and the fourth period T4) before the component replacement cycle corresponding to the first period T1 and the second period T2. Accordingly, for the pieces of data of the plurality of variables (V1, V2, . . . , and Vn), the pieces of second data can be more accurately predicted in consideration of the fluctuation in the cycle (seasonal cycle (that is, one-year cycle) or component replacement cycle) corresponding to characteristics of the variables (Va and Vb).

In some embodiments, in step S6, the pieces of second data are predicted by using a value indicating a change in the pieces of data of the plurality of variables between the third period T3 and the fourth period T4 or a change in the pieces of data of the plurality of variables between the third period T3 and the first period T1. The value indicating the change in the pieces of data of the plurality of variables between two periods may be, for example, a difference between representative values (average values or the like) of the pieces of data of the two periods.

The change in the pieces of data between the third period T3 and the fourth period T4 corresponds to the change in the pieces of data between the first period T1 and the second period T2. In this regard, in the above embodiment, the pieces of second data in the second period T2 can be appropriately predicted based on the pieces of first data in the first period T1 by using the value indicating the change in the pieces of data between the third period T3 and the fourth period T4. Alternatively, the change in the pieces of data between the third period T3 and the first period T1 corresponds to the change in the pieces of data between the fourth period T4 and the second period T2. In this regard, in the above embodiment, the pieces of second data in the second period T2 can be appropriately predicted based on the pieces of fourth data in the fourth period T4 by using the value indicating the change in the pieces of data between the third period T3 and the first period T1.

In some embodiments, in step S6, for one variable (here, Va) among the plurality of variables (V1, V2, . . . , and Vn), the pieces of second data for the variable Va are obtained by adding a value based on a difference (m₄−m₃) between an average m₄ of the pieces of fourth data for the variable Va and an average m₃ of the pieces of third data to the pieces of first data for the variable Va.

As described above, the pieces of second data can be appropriately predicted by adding the value to the pieces of first data in the first period T1 by using, as the value indicating the change in the pieces of data between the third period T3 and the fourth period T4, the value based on the difference (m₄−m₃) between the average m₄ of the pieces of fourth data and the average m₃ of the pieces of third data.

Assuming that the pieces of first data for the variable Va are d₁ and the pieces of second data for the variable Va are d₂, the pieces of second data d₂ may be represented by, for example, the following Equation (a).

d₂=d₁+(m₄−m₃) (a)

In some embodiments, the pieces of second data for the variable Va are obtained by adding, to the pieces of first data for the variable Va, a value obtained by multiplying a standard deviation σ₁ of the pieces of first data for the variable Va by a value obtained by dividing the difference (m₄−m₃) by a standard deviation σ₃ of the pieces of third data for the variable Va. In this case, assuming that the pieces of first data for the variable Va are d₁ and the pieces of second data for the variable Va are d₂, the pieces of second data d₂ can be expressed by the following Equation (A).

d₂=d₁+(m₄−m₃)/σ₃×σ₁ (A)

As described above, a value obtained by correcting the difference (m₄−m₃) between the average m₄ of the pieces of fourth data and the average m₃ of the pieces of third data by the division by the standard deviation σ₃ of the pieces of third data and the multiplication by the standard deviation σ₁ of the pieces of first data (that is, a value obtained by correcting the difference (m₄−m₃) by a ratio of the standard deviation σ₁ of the pieces of first data and the standard deviation σ₃ of the pieces of third data) is added to the pieces of first data d₁, and thus, the pieces of second data d₂ can be obtained in consideration of a change in a distribution of the pieces of data from a prescribed length of time (for example, one year or a component replacement cycle). Thus, an anomaly in the plant can be more accurately detected by using the Mahalanobis distances calculated based on the unit spaces created by using the pieces of second data d₂ obtained in this manner. In addition, the calculation may be simplified on the assumption that σ₁≈σ₃.

In some embodiments, in step S6, the pieces of second data for the variable Va are obtained by adding a value based on a difference (m₁−m₃) between the average m₁ of the pieces of first data for the variable Va and the average m₃ of the pieces of third data to the pieces of fourth data for the variable Va for one variable (here, Va) among the plurality of variables (V1, V2, . . . , and Vn).

As described above, the pieces of second data can be appropriately predicted by adding the value to the pieces of fourth data in the fourth period T4 by using, as the value indicating the change in the pieces of data between the third period T3 and the first period T1, the value based on the difference (m₁−m₃) between the average m₁ of the pieces of first data and the average m₃ of the pieces of third data.

Assuming that the pieces of fourth data for the variable Va are d₄ and the pieces of second data for the variable Va are d₂, the pieces of second data d₂ may be represented by, for example, the following Equation (b).

d₂=d₄+(m₁−m₃) (b)

In some embodiments, the pieces of second data for the variable Va are obtained by adding, to the pieces of fourth data for the variable Va, a value obtained by multiplying a value obtained by dividing the difference (m₁−m₃) by the standard deviation σ₃ of the pieces of third data for the variable Va by the standard deviation σ₄ of the pieces of fourth data for the variable Va. In this case, assuming that the pieces of fourth data for the variable Va are d₄ and the pieces of second data for the variable Va are d₂, the pieces of second data d₂ can be expressed by the following Equation (B).

d₂=d₄+(m₁−m₃)/σ₃×σ₄ (B)

As described above, a value obtained by correcting the difference (m₁−m₃) between the average m₁ of the pieces of first data and the average m₃ of the pieces of third data by the division by the standard deviation σ₃ of the pieces of third data and the multiplication by the standard deviation σ₄ of the pieces of fourth data (that is, a value obtained by correcting the difference (m₁−m₃) by a ratio of the standard deviation σ₄ of the pieces of fourth data and the standard deviation σ₃ of the pieces of third data) is added to the pieces of fourth data d₄, and thus, the pieces of second data d₂ can be obtained in consideration of the change in the distribution of the pieces of data from a previous period. Thus, an anomaly in the plant can be more accurately detected by using the Mahalanobis distances calculated based on the unit spaces created by using the pieces of second data d₂ obtained in this manner. In addition, the calculation may be simplified on the assumption that σ₃≈σ₄.

In some embodiments, the number of pieces of first data constituting the unit space created in step S8 is larger than the number of pieces of second data constituting the unit space. That is, in step S8, the pieces of data constituting the unit space are selected from among the pieces of first data and the pieces of second data such that the number of pieces of first data constituting the unit space is larger than the number of pieces of second data constituting the unit space.

In the above embodiment, since the number of pieces of first data based on the pieces of actually measured data is larger than the number of pieces of second data which are pieces of prediction data among the pieces of data constituting the unit space, the reliability of the anomaly detection based on the Mahalanobis distances calculated based on the unit spaces is satisfactory.

In some embodiments, in step S8, among the pieces of second data, pieces of data to be used for creating the unit space are randomly selected by using, for example, a random number. Then, the unit spaces are created by using the pieces of second data randomly selected and at least some of the pieces of first data.

According to the above embodiment, the unit spaces can be appropriately created by using some pieces of data randomly selected from the pieces of second data predicted in step S6 and at least some of the pieces of first data.

For example, the contents described in each embodiment are understood as follows.

(1) A plant monitoring method according to at least one embodiment of the present invention is a plant monitoring method using a Mahalanobis distance calculated from pieces of data of a plurality of variables indicating states of a plant. The method includes a step (S2) of acquiring pieces of first data which are pieces of data of a past first period (T1) up to a current point in time, a prediction step (S6) of predicting pieces of second data which are pieces of data of a second period (T2) after the current point in time, and a unit space creation step (S8) of creating a unit space which is a base for calculating the Mahalanobis distance based on the pieces of first data and the pieces of second data. In the prediction step, the pieces of second data are predicted based on pieces of third data which are pieces of data of a third period (T3) obtained by shifting the first period to the past by a prescribed length of time, pieces of fourth data which are pieces of data of a fourth period (T4) obtained by shifting the second period to the past by the prescribed length of time, and the pieces of first data.

The pieces of measurement data (for example, the temperature, the pressure, or the like) for the plurality of variables indicating the states of the plant include pieces of data that periodically fluctuate for each prescribed length of time. In addition, the fluctuations in the pieces of data between the first period and the subsequent second period correspond to the fluctuations in the pieces of data between the third period corresponding to the first period and the fourth period corresponding to the second period which are the past periods before the prescribed length of time. In this regard, in the method of the above (1), the pieces of second data can be predicted in consideration of the periodic fluctuations in the pieces of data of the plurality of variables based on the pieces of third data and the pieces of fourth data acquired in the past periods (the third period and the fourth period) before the prescribed length of time corresponding to the first period and the subsequent second period and on the pieces of first data acquired in the first period. Then, the unit spaces in which the periodic fluctuations in the pieces of data of the plurality of variables are taken into consideration can be created by using the pieces of second data predicted in this manner and the pieces of first data based on the actually measured value together. Thus, an anomaly in the plant can be accurately detected by using the Mahalanobis distances calculated based on the unit spaces created in this manner.

(2) In some embodiments, in the method of the above (1), the pieces of third data are a set of pieces of data of the variables of the third period obtained by shifting the first period to the past by the prescribed length of time defined for each of the plurality of variables, and the pieces of fourth data are a set of pieces of data of the variables of the fourth period obtained by shifting the second period to the past by the prescribed length of time defined for each of the plurality of variables.

The pieces of data of the plurality of variables indicating the states of the plant may have different fluctuation cycles depending on the characteristics of the variables. According to the method of the above (2), the shift amount of the time (that is, the prescribed length of time) from the first period and the second period to the third period and the fourth period is determined for each of the plurality of variables. That is, for each of the plurality of variables, since the prescribed length of time corresponding to the fluctuation cycle of the data of the variable can be defined, the pieces of third data and the pieces of fourth data which are the sets of pieces of past data before the prescribed length of time corresponding to the characteristics of each variable are used, and thus, the prediction accuracy of the pieces of second data can be improved.

(3) In some embodiments, in the method of the above (1) or (2), the prescribed length of time defined for at least one variable among the plurality of variables is one year.

The pieces of data of the plurality of variables indicating the states of the plant usually include pieces of data that fluctuate in a one-year cycle depending on the season. According to the method of the above (3), since the pieces of second data are predicted by using the pieces of third data and the pieces of fourth data including the data for the at least one variable acquired in the periods (the third period and the fourth period) one year before the periods corresponding to the first period and the second period, the pieces of second data can be accurately predicted in consideration of the seasonal fluctuation in the data of the variable.

(4) In some embodiments, in the method of the above (3), the prescribed length of time defined for at least one other variable among the plurality of variables is a component replacement cycle of plant constituent equipment related to the one other variable.

The pieces of data of the plurality of variables indicating the states of the plant may include pieces of data that fluctuate in the component replacement cycle of the plant constituent equipment related to the variable. According to the method of the above (4), the pieces of second data are predicted by using the pieces of third data and the pieces of fourth data including the data for the at least one variable acquired in the periods (the third period and the fourth period) one year before the periods corresponding to the first period and the second period and the data for the at least one other variable acquired in the periods (the third period and the fourth period) before the component replacement cycle corresponding to the first period and the second period. Accordingly, for the pieces of data of the plurality of variables, the pieces of second data can be more accurately predicted in consideration of the fluctuation in the cycle (the seasonal cycle (that is, one-year cycle) or the component replacement cycle) corresponding to the characteristics of each variable.

(5) In some embodiments, in the method of any of the above (1) to (4), in the prediction step, the pieces of second data are predicted by using a value indicating a change in the pieces of data between the third period and the fourth period or a change in the pieces of data between the third period and the first period.

The change in the pieces of data between the third period and the fourth period corresponds to the change in the pieces of data between the first period and the second period. In addition, the change in the pieces of data between the third period and the first period corresponds to the change in the pieces of data between the fourth period and the second period. According to the method of the above (5), the pieces of second data in the second period can be appropriately predicted based on the pieces of first data in the first period by using the value indicating the change in the pieces of data between the third period and the fourth period. Alternatively, according to the method of the above (5), the pieces of second data in the second period can be appropriately predicted based on the pieces of fourth data in the fourth period by using the value indicating the change in the pieces of data between the third period and the first period.

(6) In some embodiments, in the method of any of the above (1) to (5), in the prediction step, the pieces of second data are obtained by adding, to the pieces of first data, a value based on a difference between an average of the pieces of fourth data and an average of the pieces of third data for one variable among the plurality of variables.

According to the method of the above (6), the pieces of second data can be appropriately acquired by adding the value to the pieces of first data in the first period by using the value based on the difference between the average of the pieces of fourth data and the average of the pieces of third data as the value indicating the change in the pieces of data between the third period and the fourth period.

(7) In some embodiments, in the method of the above (6), the pieces of second data are obtained by adding, to the pieces of first data, a value obtained by multiplying a value obtained by dividing the difference by a standard deviation of the pieces of third data by a standard deviation of the pieces of first data.

According to the method of the above (7), the pieces of second data can be obtained in consideration of the change in the distribution of the pieces of data from one year ago by adding, to the pieces of first data, the value obtained by correcting the difference between the average of the pieces of fourth data and the average of the pieces of third data by the division by the standard deviation of the pieces of third data and the multiplication by the standard deviation of the pieces of first data. Thus, an anomaly in the plant can be more accurately detected by using the Mahalanobis distances calculated based on the unit spaces created by using the pieces of second data obtained in this manner.

(8) In some embodiments, in the method of any of the above (1) to (5), in the prediction step, the pieces of second data are obtained by adding, to the pieces of fourth data, a value based on a difference between an average of the pieces of first data and an average of the pieces of third data for one variable among the plurality of variables.

According to the method of the above (8), the pieces of second data can be appropriately acquired by adding the value to the pieces of fourth data in the fourth period by using the value based on the difference between the average of the pieces of first data and the average of the pieces of third data as the value indicating the change in the pieces of data between the third period and the first period.

(9) In some embodiments, in the method of the above (8), the pieces of second data are obtained by adding, to the pieces of fourth data, a value obtained by multiplying a value obtained by dividing the difference by a standard deviation of the pieces of third data by a standard deviation of the pieces of fourth data.

According to the method of the above (9), the pieces of second data can be obtained in consideration of the change in the distribution of the pieces of data from the previous period by adding, to the pieces of fourth data, the value obtained by correcting the difference between the average of the pieces of first data and the average of the pieces of third data by the division by the standard deviation of the pieces of third data and the multiplication by the standard deviation of the pieces of fourth data. Thus, an anomaly in the plant can be more accurately detected by using the Mahalanobis distances calculated based on the unit spaces created by using the pieces of second data obtained in this manner.

(10) In some embodiments, in the method of any of the above (1) to (9), the number of the pieces of first data constituting the unit space is larger than the number of the pieces of second data constituting the unit space.

According to the method of the above (10), since the number of pieces of first data based on the pieces of actually measured data is larger than the number of pieces of second data which are the pieces of prediction data among the pieces of data constituting the unit space, the reliability of the anomaly detection based on the Mahalanobis distance calculated based on the unit space is satisfactory.

(11) In some embodiments, in the method of any of the above (1) to (10), the plant monitoring method further includes a step of randomly selecting pieces of data used for creating the unit space among the pieces of second data. In the unit space creation step, the unit space is created by using the pieces of data selected in the selection step and at least some of the pieces of first data.

According to the method of the above (11), the unit spaces can be appropriately created by using some pieces of data randomly selected among the pieces of predicted second data and at least some of the pieces of first data.

(12) A plant monitoring device (40) according to at least one embodiment of the present invention is a plant monitoring device using a Mahalanobis distance calculated from pieces of data of a plurality of variables indicating states of a plant. The device includes an acquisition unit (42) configured to acquire pieces of first data which are pieces of data of a past first period (T1) up to a current point in time, a prediction unit (44) configured to predict pieces of second data which are pieces of data of a second period (T2) after the current point in time, and a unit space creation unit (46) configured to create a unit space which is a base for calculating the Mahalanobis distance based on the pieces of first data and the pieces of second data. The prediction unit is configured to predict the pieces of second data based on pieces of third data which are pieces of data of a third period (T3) obtained by shifting the first period to the past by a prescribed length of time, pieces of fourth data which are pieces of data of a fourth period (T4) obtained by shifting the second period to the past by the prescribed length of time, and the pieces of first data.

The pieces of measurement data (for example, the temperature, the pressure, or the like) for the plurality of variables indicating the states of the plant include pieces of data that periodically fluctuate for each prescribed length of time. In addition, the fluctuations in the pieces of data between the first period and the subsequent second period correspond to the fluctuations in the pieces of data between the third period corresponding to the first period and the fourth period corresponding to the second period which are the past periods before the prescribed length of time. In this regard, in the configuration of the above (12), the pieces of second data can be predicted in consideration of the periodic fluctuations in the pieces of data of the plurality of variables based on the pieces of third data and the pieces of fourth data acquired in the past periods (the third period and the fourth period) before the prescribed length of time corresponding to the first period and the subsequent second period and on the pieces of first data acquired in the first period. Then, the unit spaces in which the periodic fluctuations in the pieces of data of the plurality of variables are taken into consideration can be created by using the pieces of second data predicted in this manner and the pieces of first data based on the actually measured value together. Thus, an anomaly in the plant can be accurately detected by using the Mahalanobis distances calculated based on the unit spaces created in this manner.

(13) A plant monitoring program according to at least one embodiment of the present invention is a plant monitoring program using a Mahalanobis distance calculated from pieces of data of a plurality of variables indicating states of a plant causing a computer to execute a procedure of acquiring pieces of first data which are pieces of data of a past first period (T1) up to a current point in time, a procedure of predicting pieces of second data which are pieces of data of a second period (T2) after the current point in time, and a procedure of creating a unit space which is a base for calculating the Mahalanobis distance based on the pieces of first data and the pieces of second data. In the procedure of predicting the pieces of second data, the pieces of second data are predicted based on pieces of third data which are pieces of data of a third period (T3) obtained by shifting the first period to the past by a prescribed length of time, pieces of fourth data which are pieces of data of a fourth period (T4) obtained by shifting the second period to the past by the prescribed length of time, and the pieces of first data.

The pieces of measurement data (for example, the temperature, the pressure, or the like) for the plurality of variables indicating the states of the plant include pieces of data that periodically fluctuate for each prescribed length of time. In addition, the fluctuations in the pieces of data between the first period and the subsequent second period correspond to the fluctuations in the pieces of data between the third period corresponding to the first period and the fourth period corresponding to the second period which are the past periods before the prescribed length of time. In this regard, in the configuration of the above (13), the pieces of second data can be predicted in consideration of the periodic fluctuations in the pieces of data of the plurality of variables based on the pieces of third data and the pieces of fourth data acquired in the past periods (the third period and the fourth period) before the prescribed length of time corresponding to the first period and the subsequent second period and on the pieces of first data acquired in the first period. Then, the unit spaces in which the periodic fluctuations in the pieces of data of the plurality of variables are taken into consideration can be created by using the pieces of second data predicted in this manner and the pieces of first data based on the actually measured value together. Thus, an anomaly in the plant can be accurately detected by using the Mahalanobis distances calculated based on the unit spaces created in this manner.

Although the embodiments of the present invention have been described, the present invention is not limited to the above-described embodiments, and includes modifications of the above-described embodiments and a combination of these embodiments as appropriate.

In the present specification, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous” indicating that things are in an equal state does not strictly represent only the equal state, but also a tolerance or a state where there is a difference to the extent that the same function can be obtained.

In addition, in the present specification, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

In addition, in the present specification, expressions such as “comprising”, “including”, or “having” one component are not exclusive expressions excluding the presence of other components.

### REFERENCE SIGNS LIST

10 gas turbine
12 compressor
14 combustor
15 rotor
16 turbine
18 generator
30 measurement unit
32 storage unit
40 plant monitoring device
42 data acquisition unit
44 prediction unit
46 unit space creation unit
48 Mahalanobis distance calculation unit
50 anomaly determination unit
60 display unit
A region
T1 first period
T2 second period
T3 third period
T4 fourth period

1. A plant monitoring method using a Mahalanobis distance calculated from pieces of data of a plurality of variables indicating states of a plant, the method comprising:
a step of acquiring pieces of first data which are pieces of data of a past first period up to a current point in time;
a prediction step of predicting pieces of second data which are pieces of data of a second period after the current point in time; and
a unit space creation step of creating a unit space which is a base for calculating the Mahalanobis distance based on the pieces of first data and the pieces of second data,
wherein, in the prediction step, the pieces of second data are predicted based on pieces of third data which are pieces of data of a third period obtained by shifting the first period to the past by a prescribed length of time, pieces of fourth data which are pieces of data of a fourth period obtained by shifting the second period to the past by the prescribed length of time, and the pieces of first data.

2. The plant monitoring method according to claim 1,
wherein the pieces of third data are a set of pieces of data of the variables of the third period obtained by shifting the first period to the past by the prescribed length of time defined for each of the plurality of variables, and
the pieces of fourth data are a set of pieces of data of the variables of the fourth period obtained by shifting the second period to the past by the prescribed length of time defined for each of the plurality of variables.

3. The plant monitoring method according to claim 1, wherein the prescribed length of time defined for at least one variable among the plurality of variables is one year.

4. The plant monitoring method according to claim 3, wherein the prescribed length of time defined for at least one other variable among the plurality of variables is a component replacement cycle of plant constituent equipment related to the one other variable.

5. The plant monitoring method according to claim 1, wherein, in the prediction step, the pieces of second data are predicted by using a value indicating a change in the pieces of data between the third period and the fourth period or a change in the pieces of data between the third period and the first period.

6. The plant monitoring method according to claim 1, wherein, in the prediction step, the pieces of second data are obtained by adding, to the pieces of first data, a value based on a difference between an average of the pieces of fourth data and an average of the pieces of third data for one variable among the plurality of variables.

7. The plant monitoring method according to claim 6, wherein the pieces of second data are obtained by adding, to the pieces of first data, a value obtained by multiplying a value obtained by dividing the difference by a standard deviation of the pieces of third data by a standard deviation of the pieces of first data.

8. The plant monitoring method according to claim 1, wherein, in the prediction step, the pieces of second data are obtained by adding, to the pieces of fourth data, a value based on a difference between an average of the pieces of first data and an average of the pieces of third data for one variable among the plurality of variables.

9. The plant monitoring method according to claim 8, wherein the pieces of second data are obtained by adding, to the pieces of fourth data, a value obtained by multiplying a value obtained by dividing the difference by a standard deviation of the pieces of third data by a standard deviation of the pieces of fourth data.

10. The plant monitoring method according to claim 1, wherein the number of the pieces of first data constituting the unit space is larger than the number of the pieces of second data constituting the unit space.

11. The plant monitoring method according to claim 1, further comprising:
a step of randomly selecting pieces of data used for creating the unit space among the pieces of second data,
wherein, in the unit space creation step, the unit space is created by using the pieces of data selected in the selection step and at least some of the pieces of first data.

12. A plant monitoring device using a Mahalanobis distance calculated from pieces of data of a plurality of variables indicating states of a plant, the device comprising:
an acquisition unit configured to acquire pieces of first data which are pieces of data of a past first period up to a current point in time;
a prediction unit configured to predict pieces of second data which are pieces of data of a second period after the current point in time; and
a unit space creation unit configured to create a unit space which is a base for calculating the Mahalanobis distance based on the pieces of first data and the pieces of second data,
wherein the prediction unit is configured to predict the pieces of second data based on pieces of third data which are pieces of data of a third period obtained by shifting the first period to the past by a prescribed length of time, pieces of fourth data which are pieces of data of a fourth period obtained by shifting the second period to the past by the prescribed length of time, and the pieces of first data.

13. A plant monitoring program using a Mahalanobis distance calculated from pieces of data of a plurality of variables indicating states of a plant causing a computer to execute:
a procedure of acquiring pieces of first data which are pieces of data of a past first period up to a current point in time;
a procedure of predicting pieces of second data which are pieces of data of a second period after the current point in time; and
a procedure of creating a unit space which is a base for calculating the Mahalanobis distance based on the pieces of first data and the pieces of second data,
wherein, in the procedure of predicting the pieces of second data, the pieces of second data are predicted based on pieces of third data which are pieces of data of a third period obtained by shifting the first period to the past by a prescribed length of time, pieces of fourth data which are pieces of data of a fourth period obtained by shifting the second period to the past by the prescribed length of time, and the pieces of first data.
